(19) United States
(12) Patent Application Publication
(10) Pub. No.: US 2010/0092234 A1
(43) Pub. Date: Apr. 15, 2010

(54) ACCESSORY SECURING MECHANISM

(75) Inventors: YU ZHANG, Shenzhen City (CN); SHUI-JIN DONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/534,314

(22) Filed: Aug. 3, 2009

(30) Foreign Application Priority Data
Oct. 10, 2008 (CN) 200810304880.6

(51) Int. Cl. F16B 17/00

(52) U.S. Cl. 403/23; 403/24

(57) ABSTRACT

An accessory securing mechanism in electronic device includes a housing member defining an assembling recess, an engaging member detachably assembled in the assembling recess, a string detachably affixed to the engaging member, and a cover member; the engaging member is detachably assembled in the assembling recess, the string is detachably affixed to the engaging member and an end of the string extends out the assembling recess, the cover member covers the housing member.

### BACKGROUND

1. Technical Field

The present disclosure relates to an accessory securing mechanism for a portable electronic device.

2. Description of Related Art

With development of wireless communication technology, portable electronic devices such as mobile phones are widely used. A typical accessory securing mechanism has a through aperture defined in a housing member of the portable electronic device. The through aperture has two connecting opening ends at the housing member, and accordingly forms a hanging wall therebetween. To assemble an accessory such as a string to the portable electronic device, the string is usually passed through one opening end and extends out from the other opening end. The string can be twisted to hang on the hang wall. However, the hanging wall may fail when the string is pulled with a large force, thus, the housing member is broken and hardly to repair it.

Therefore, there is room for improvement within the art.

### BRIEF DESCRIPTION OF THE DRAWING

Many aspects of the present accessory securing mechanism in electronic device can be better understood with reference to the following drawings. The components in the various drawings are not necessarily drawn to scale, the emphasis instead being placed upon clearly illustrating the principles of the present accessory securing mechanism in electronic device. Moreover, in the drawings, like reference numerals designate corresponding parts throughout the diagrams.

FIG. 1 is an exploded, isometric view of an accessory securing mechanism in electronic device according to an exemplary embodiment.

FIG. 2 is an assembled partly, isometric view of the assembly structure shown in FIG. 1.

FIG. 3 is an assembled integrally, isometric view of the assembly structure shown in FIG. 1.

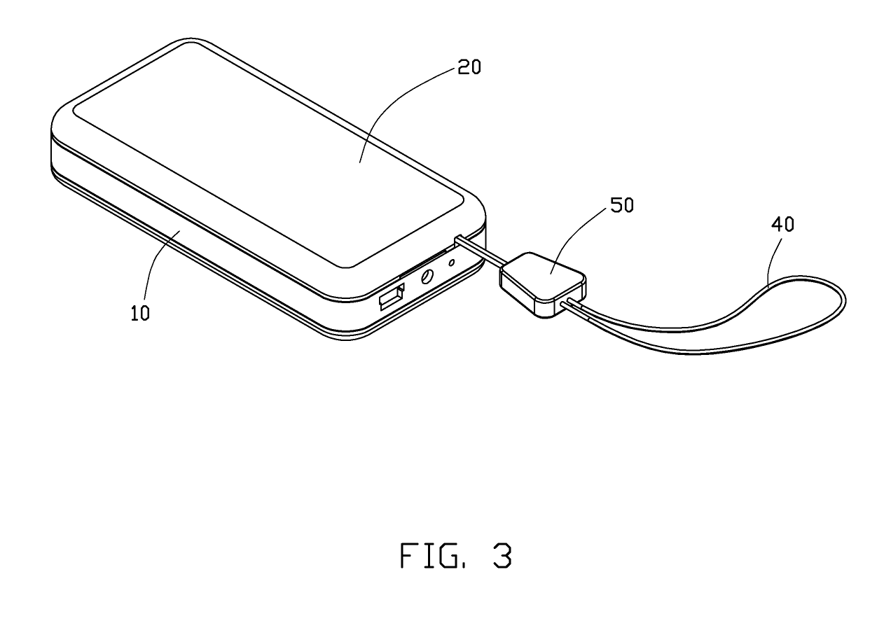

### DETAILED DESCRIPTION OF THE EMBODIMENT

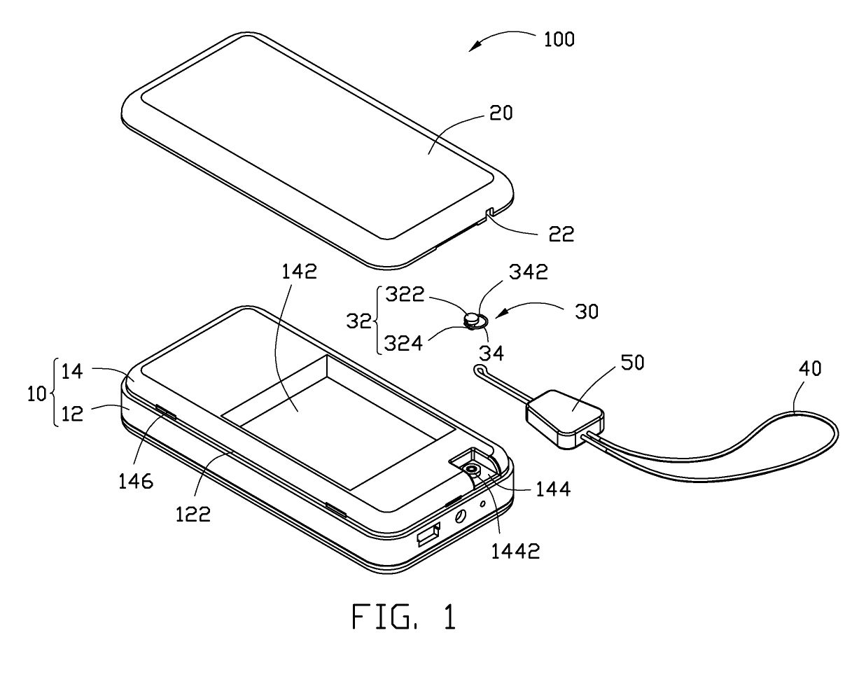

Referring to FIG. 1, an exemplary accessory securing mechanism 100, which can be used in mobile phones and other portable electronic devices, includes a housing member 10, a cover member 20, an engaging member 30, and a string 40.

The housing member 10 includes a main body portion 12 and a cover portion 14. The cover portion 14 protrudes from the main body portion 12 to form a stepped engaging flange 122 abutting the main body portion 12. The covering portion 14 is configured for engaging with the cover member 20 and defines a receiving cavity 142 at the middle and an assembling recess 144 through the flange 122. The assembling recess 144 defines an assembling hole 1442 in the bottom to latch the engaging member 30 therein. In this embodiment, the assembling hole 1442 is extended by a hollow nut (not shown) aligning and communicating with of the assembling hole 1442. The hollow nut is disposed in the bottom of the assembling recess 144, on top of the assembling hole 1442. The covering portion 14 includes a plurality of spaced latches 146 on the periphery above the engaging flange 122 for latching with the cover member 20.

The cover member 20 defines a narrow cutout 22 at an end corresponding to the assembling recess 144 for receiving the string 40. The cover member 20 defines a plurality of latching cavities (not shown) to latch with the latches 146 of the housing member 10.

The engaging member 30 includes a connecting pole 32 and a connecting loop 34 secured to the connecting pole 32. The connecting pole 32 includes an end portion 322 and a pole portion 324 protruding from an end of the end portion 322. The pole portion 324 is smaller than the end portion 322 in diameter. The end portion 322 defines two opposite circumferential latching holes (not labeled) to secure the connecting loop 34 therein. The pole portion 324 corresponds to the assembling hole 1442 in shape and size. The pole portion 324 is used to engage into (e.g., screwed into) the assembling hole 1442. The connecting loop 34 includes two opposite folding sections 342 latched into the latching holes of the end portion 322.

The string 40 is an enclosed loop. A slider 50 is slidably coiled around the string 40 and separates the string 40 into two semi-loops.

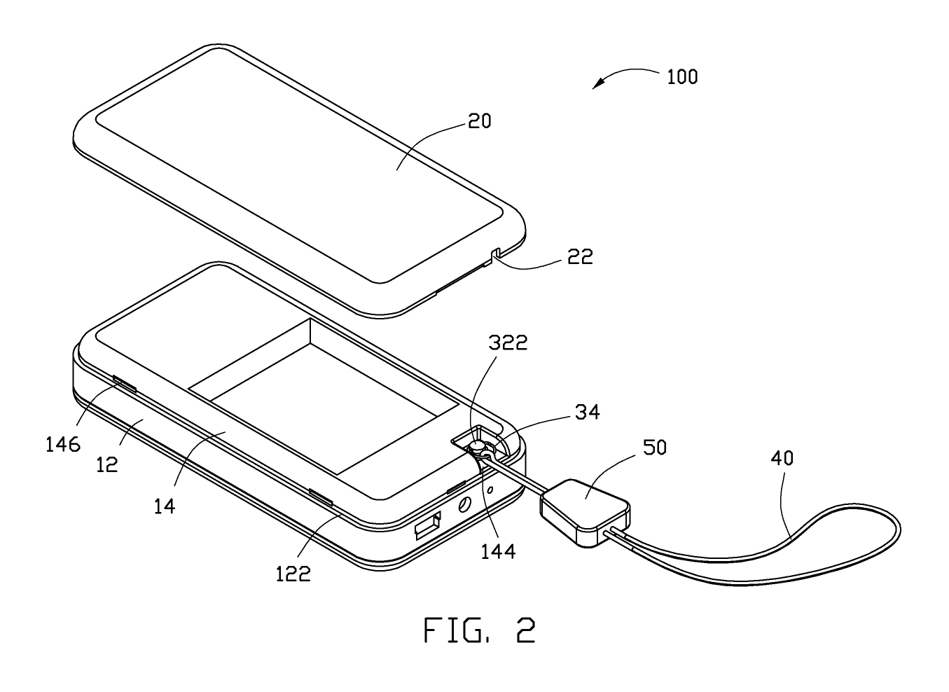

Referring to FIG. 2, to assemble the accessory securing mechanism 100, the string 40 is affixed to the engaging member 30, wherein an end of the string 40 is hung on the connecting loop 34. The engaging member 30 is mounted to the housing member 10. At this stage, the pole portion 324 of the engaging member 30 is inserted and fixed into the assembling hole 1442 of the housing member 10, the remainder of the string 40 is left out of the assembling recess 144. The cover member 20 is latched to the housing member 10 by latching of the latches into the latching cavities of the cover member 20. The string 10 passes through the cutout 22 to the outside.

The string 40 is easy to assemble in the housing member 10. Moreover, the housing member 10 can withstand a great amount of force without breaking. When the connecting loop 34 is broken, it is simple to replace the engaging member 30 with another new connecting loop 34.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An accessory securing mechanism, comprising:
a housing member defining an assembling recess;
an engaging member detachably assembled in the assembling recess;
a string detachably affixed to the engaging member; and
a cover member;
wherein the engaging member is detachably assembled in the assembling recess, the string is affixed to the engaging member and an end of the string extends out the assembling recess, the cover member covers the housing member.

2. The accessory securing mechanism as claimed in claim 1, wherein the assembling recess forms an assembling hole at the bottom, the engaging member includes a connecting pole having a pole portion, the pole portion is inserted and fixed into the assembling hole.

3. The accessory securing mechanism as claimed in claim 2, wherein engaging member includes a connecting loop, the string hung on the connecting loop.

4. The accessory securing mechanism as claimed in claim 3, wherein the connecting pole includes an end portion connecting to the pole portion, the end portion defines latching holes to latch with the connecting loop.

5. The accessory securing mechanism as claimed in claim 1, wherein the cover member defines a cutout corresponding to the assembling recess of the housing member, the cutout configured for receiving the string.

6. The accessory securing mechanism as claimed in claim 1, wherein the housing member forms latches at the periphery, the cover member forms latching cavities correspondingly to engage with the latches.

7. The accessory securing mechanism as claimed in claim 1, wherein the housing member includes a main body portion and a covering portion protruding from the main body portion, the covering portion defines a receiving cavity for receiving a battery and the assembling recess.

8. An accessory securing mechanism, comprising:
a housing member defining an assembling recess;
an engaging member detachably assembled in the assembling recess; and
a string detachably affixed to the engaging member;
wherein the engaging member is detachably assembled in the assembling recess, the string is detachably affixed to the engaging member and an end of the string extends out the assembling recess.

9. The accessory securing mechanism as claimed in claim 8, wherein the accessory securing mechanism also includes a cover member to cover member the housing member.

10. The accessory securing mechanism as claimed in claim 8, wherein the assembling recess forms an assembling hole at the bottom, the engaging member includes a connecting pole having a pole portion, the pole portion is inserted and fixed into the assembling hole.

11. The accessory securing mechanism as claimed in claim 10, wherein engaging member includes a connecting loop, the string hung on the connecting loop.

12. The accessory securing mechanism as claimed in claim 11, wherein the connecting pole includes an end portion connecting to the pole portion, the end portion defines latching holes to latch with the connecting loop.
